(19) United States
(12) Patent Application Publication
(10) Pub. No.: US 2009/0015551 A1
(43) Pub. Date: Jan. 15, 2009

(54) Integrated structure for directional wheel support and signal trigerring

(75) Inventor: Chin-Wen Chou, Taipei Hsien (TW)

Correspondence Address: Joe McKinney Muncy, PO Box 1364, Fairfax, VA, 22038-1364, US

(73) Assignee: ZIPPY TECHNOLOGY CORP.

(21) Appl. No.: 11/822,616

(22) Filed: Jul. 9, 2007

(51) Int. Cl. G06F 3/033

(52) U.S. Cl. 345/157

(57) ABSTRACT

The present invention includes a directional wheel which has a roller movable under a force. The roller has two sides forming a first and a second leaning portions that are held by a first and a second support structures. The first support structure and the second support structure have respectively a first moving end and a second moving end movable by the first leaning portion and the second leaning portion. A first contact and a second contact are provided respectively in the moving range of the first and second moving ends to connect the first and second moving ends to generate signals. The first and second leaning portions keep two sides of the direction wheel in a balanced manner in regular conditions. The directional wheel is movable under a force to synchronously move the first and second support structures in the direction of the force to generate a corresponding signal.

### FIELD OF THE INVENTION

The present invention relates to an integrated structure and particularly to an integrated structure to support a direction wheel and trigger signals.

### BACKGROUND OF THE INVENTION

Computer input devices using a roller such as mice or keyboards are known in the art. U.S. Pat. No. 6,700,564 B2 granted to Microsoft Co. and U.S. patent publication No. 2003/0025673 A1 disclose an input device which has a roller to allow users to turn the roller with fingers to change pages, scroll text or edit text of documents during browsing the documents on a computer screen. It is especially convenient for the users to browse the documents, search Web pages or zoom/shrink images and skip pages or lines without striking the page down/up keys on the keyboard, or maneuvering the scroll bar on the browsing window through a mouse.

However the conventional roller device is complicated and bulky. Fabrication and assembly are difficult. Manufacturing cost is higher. To shrink the size of electronic products equipped with such a roller input device also is not easy.

### SUMMARY OF THE INVENTION

The primary object of the present invention is to provide a structure to integrate directional wheel support and signal triggering, and simplify a roller input structure and reduce the size to facilitate fabrication and assembly, and shrink the size of products.

To achieve the foregoing object, the integrated structure of the invention includes a directional wheel which has a roller movable under forces with two sides forming respectively a first leaning portion and a second leaning portion, a first support structure to hold the first leaning portion that has at least one first moving end movable by the first leaning portion and a first contact located within the moving range of the first moving end to be triggered thereof to generate a first signal, and a second support structure to hold the second leaning portion that has at least one second moving end movable by the second leaning portion and a second contact located within the moving range of the second moving end to be triggered thereof to generate a second signal. The directional wheel has a left side and a right side held by the first and second support structures in a balanced manner in regular conditions. The directional wheel can be moved under a force to synchronously move the first and second support structures in the force applying direction to generate corresponding signals. The integrated structure thus formed can support the direction wheel and trigger signals.

The foregoing, as well as additional objects, features and advantages of the invention will be more readily apparent from the following detailed description, which proceeds with reference to the accompanying drawings. The embodiment discussed below serves only for illustrative purpose, and is not the limitation of the invention.

### BRIEF DESCRIPTION OF THE DRAWINGS

FIG. 1 is a perspective view of an embodiment of the invention.

FIG. 2 is a front view of an embodiment of the invention.

FIG. 3A is a schematic view of a first support structure of an embodiment of the invention.

FIG. 3B is a schematic view of the first support structure of an embodiment of the invention in an operating condition.

FIG. 3C is a schematic view of the first support structure of an embodiment of the invention in another operating condition.

FIG. 4A is a schematic view of a second support structure of an embodiment of the invention.

FIG. 4B is a schematic view of the second support structure of an embodiment of the invention in an operating condition.

FIG. 5 is a side view of the second support structure of an embodiment of the invention.

### DETAILED DESCRIPTION OF THE PREFERRED EMBODIMENT

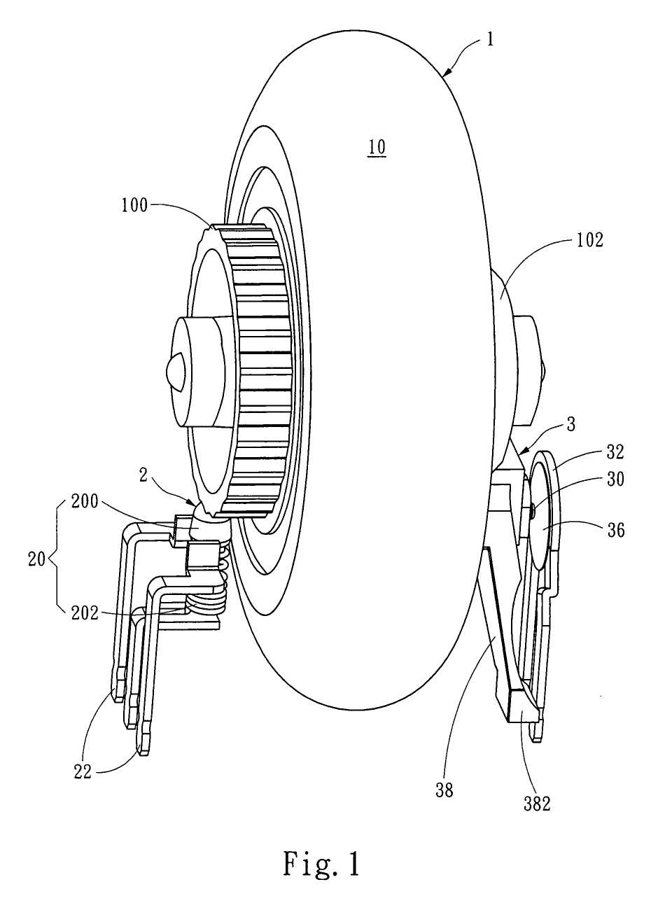

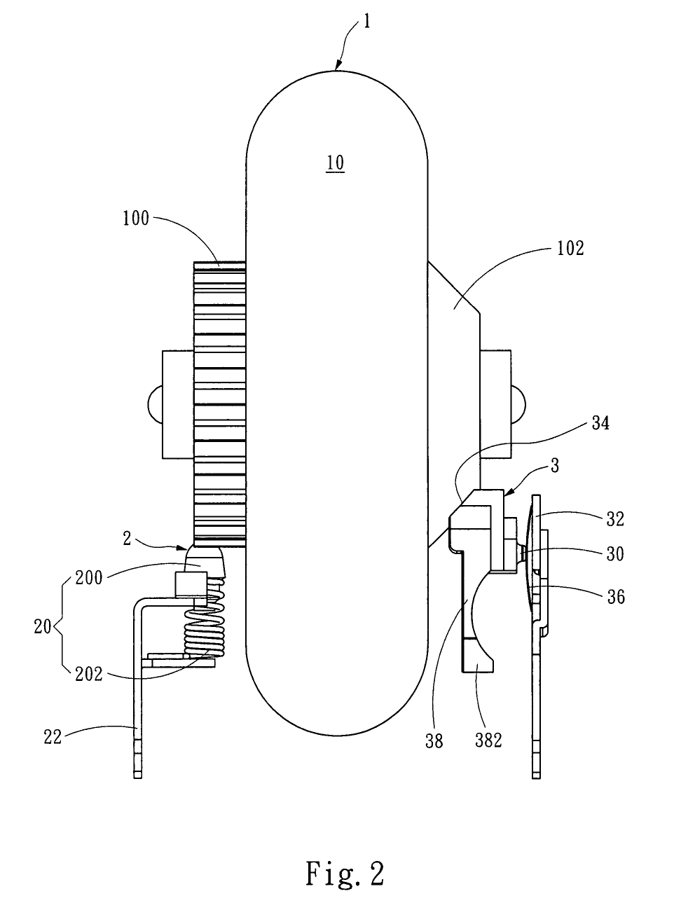

Refer to FIGS. 1 and 2 for an embodiment of the integrated structure for directional wheel support and signal triggering of the invention. It includes:

a directional wheel 1 which is depressible downwards and turnable forwards and rearwards. It has a roller 10 movable under a force. The roller 10 has a left side forming a first leaning portion 100 and a right side forming a second leaning portion 102. In this embodiment the first leaning portion 100 is a coaxial gear and the second leaning portion 102 is a coaxial annular sloped surface;

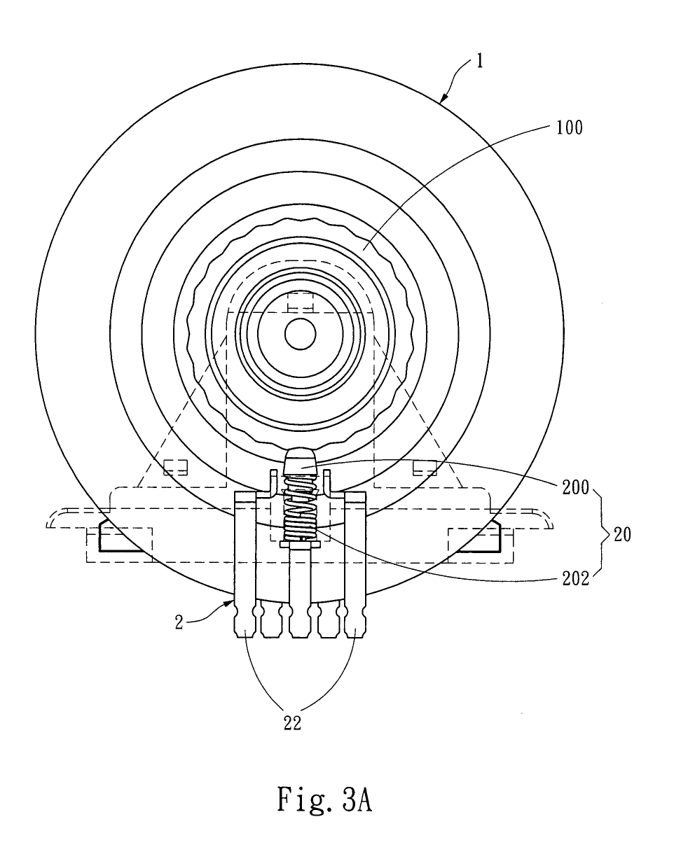

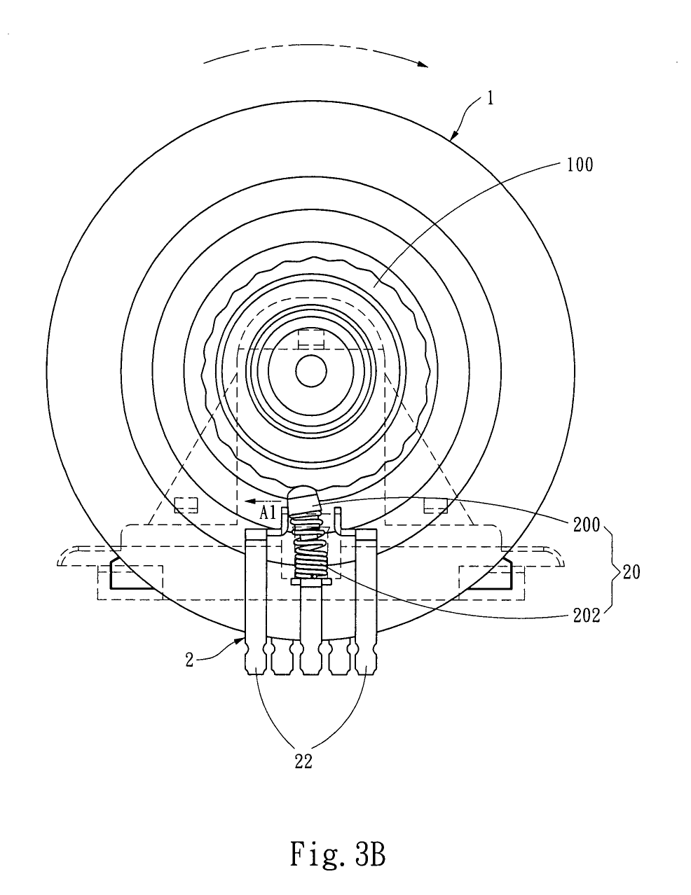

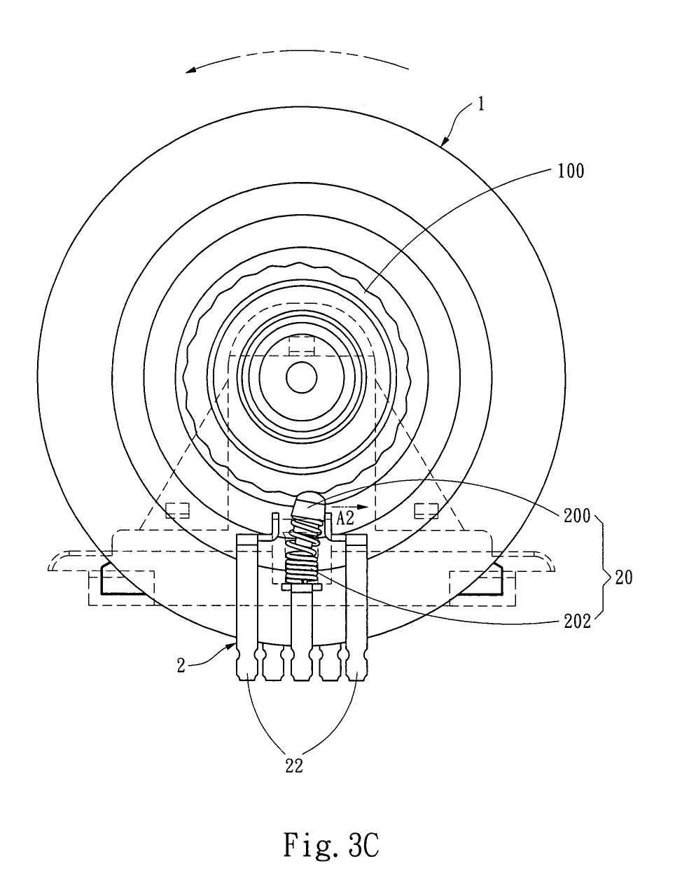

a first support structure 2 (also referring to FIGS. 3A, 3B and 3C) which holds the first leaning portion 100 and has at least one first moving end 20 movable by the first leaning portion 100. There is a first contact 22 located within the moving range A1 and A2 of the first moving end 20 to be triggered by the first moving end 20 to generate a first signal. In this embodiment the first moving end 20 is conductive and elastic and consists of a metal pin 200 and an elastic element 202 (such as a spring) connecting to one end of the metal pin 200. The metal pin 200 has a top end constantly in contact with a gear surface of the first leaning portion 100. When the directional wheel 1 is turned, the gear surface of the first leaning portion 100 moves the top end of the metal pin 200 to cause the first contact 22 to generate a first rolling signal. When the directional wheel 1 is still the first moving end 20 returns to its regular position due to its elasticity and stops generating the first rolling signal. The embodiment of the first moving end 20 previously discussed is not the limitation of the invention. It also may be formed through a spring, or a metal ring run through by a plastic pin to be coupled with a metal spring connecting to the metal ring; and

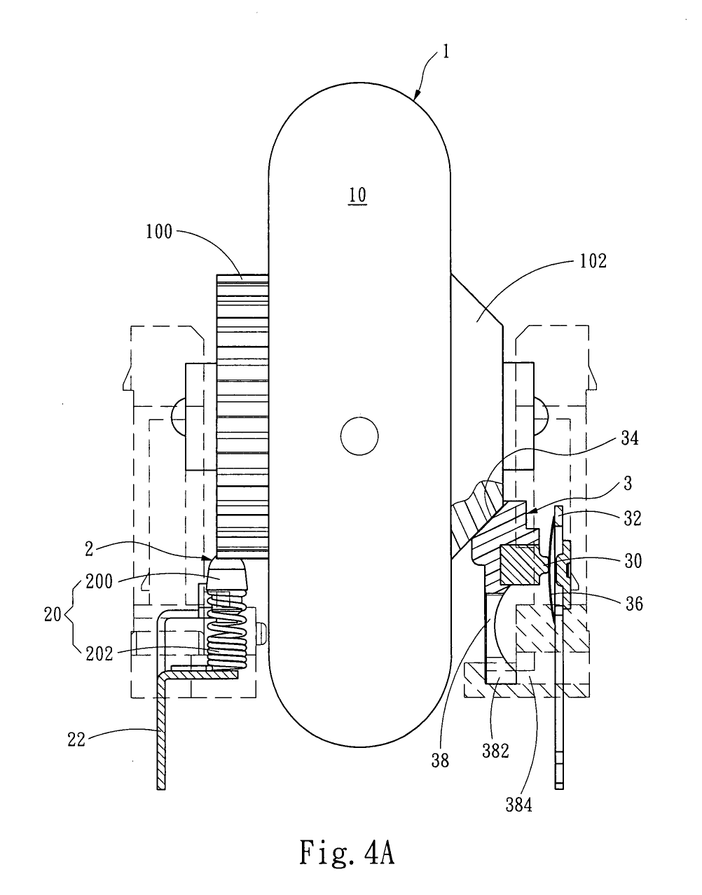

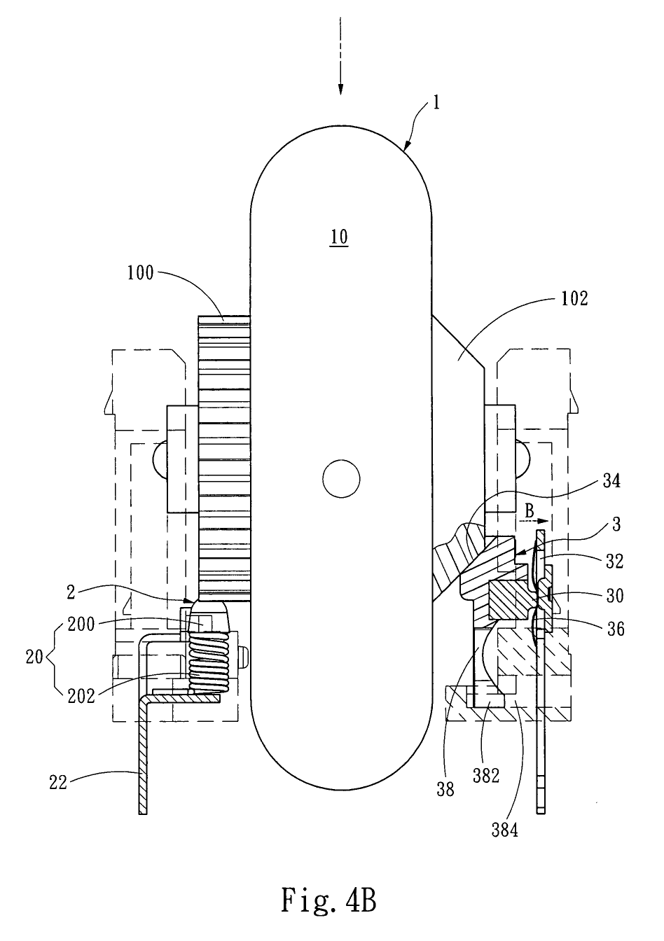

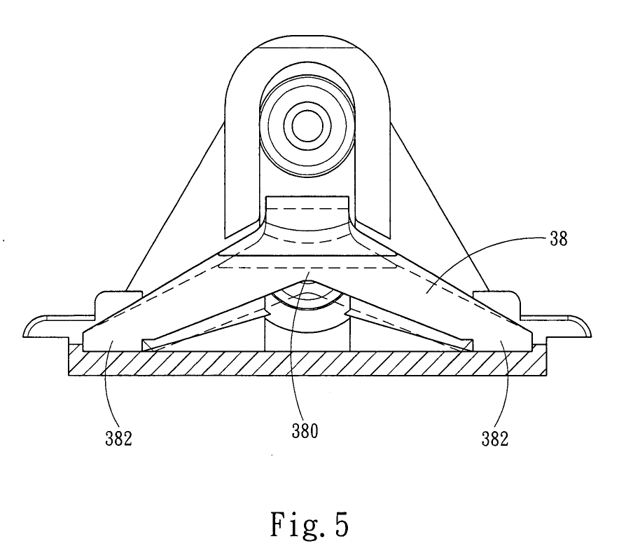

a second support structure 3 (also referring to FIGS. 4A and 4B) which holds the second leaning portion 102 and has at least one second moving end 30 movable by the second leaning portion 102. There is a second contact 32 located within the moving range B of the second moving end 30 to be triggered by the second moving end 30 to generate a second signal. In this embodiment the second support structure 3 has a chamfered surface 34 corresponding to the coaxial annular sloped surface of the second leaning portion 102, a conductive elastic blade 36 and a support leg 38 located at the bottom end of the second support structure 3 (also referring to FIG. 5). The elastic blade 36 is located on the moving path of the second moving end 30. When the directional wheel 1 is depressed downwards, the coaxial annular sloped surface of the second leaning portion 102 and the chamfered surface 34 direct the second moving end 30 towards the elastic blade 36 so that the elastic blade 36 connects the second contact 32, thus the second contact 32 outputs a depressing signal. The support leg 38 is elastic and has a bend spot 380. When the support leg 38 receives a force from an upper side, the bend spot 380 serves as a flexible fulcrum to allow the support leg 38 to be moved downwards and bounce back. The support leg 38 has a sliding portion 382 at the bottom end mounting onto a sliding track 384. By means of guiding of the sliding track 384 and the sliding portion 382, the second support structure 3 can be slid reciprocally. The first and second contacts 22 and 32 function as a first electrode and a second electrode to detect respectively the movement of the first and second moving ends 20 and 30. The conductive conditions of the first and second electrodes alter when the first and second moving ends 20 and 30 are moved. Thereby the signals to be generated can be determined. When the elastic blade 36 is pressed by the second moving end 30, the support leg 38 at the bottom end of the second support structure 3 provides elasticity to move the directional wheel 1 upwards to its original position. In addition, in regular conditions, through the leftward and rightward moving displacement of the directional wheel 1 and the slope of the chamfered surface 34, a space gap between the chamfered surface 34 and the coaxial annular sloped surface of the second leaning portion 102 or direct contact without a gap can be determined.

The left and right sides of the directional wheel 1 are supported and maintained in a balanced state in the regular conditions by means of the first and second support structures 2 and 3. Moreover, the directional wheel 1 can be moved under a force to drive the first and second support structures 2 and 3 synchronously in the force direction to generate a corresponding signal. The integrated structure thus formed can support the direction wheel and also trigger the signals.

In short, through the first and second support structures 2 and 3 of the invention, the support structure and signal triggering of the directional wheel 1 can be integrated. The roller input device is simplified and the size is smaller.

Fabrication and assembly also are easier. The products adopted this invention can be made more compact.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An integrated structure for directional wheel support and signal triggering, comprising:
a directional wheel having a roller which has two sides formed respectively a first leaning portion and a second leaning portion;
a first support structure which holds the first leaning portion and has at least one first moving end movable by the first leaning portion and a first contact located within a first moving range of the first moving end to be connected by the first moving end to generate a first signal; and
a second support structure which holds the second leaning portion and has at least one second moving end movable by the second leaning portion and a second contact located within a second moving range of the second moving end to be connected by the second moving end to generate a second signal;
wherein the direction wheel has a left side and a right side held by the first support structure and the second support structure in a balanced manner, and is movable under a force to move synchronously the first support structure and the second support structure in the direction of the force to generate a corresponding signal.

2. The integrated structure of claim 1, wherein the first leaning portion is a coaxial gear.

3. The integrated structure of claim 2, wherein the coaxial gear has a gear surface to move the first moving end when the directional wheel is turned to make the first contact to generate a rolling signal.

4. The integrated structure of claim 3, wherein the first moving end has a metal pin and an elastic element connecting to the metal pin, the metal pin having a top end constantly in contact with the gear surface.

5. The integrated structure of claim 4, wherein the elastic element is a spring.

6. The integrated structure of claim 1, wherein the second leaning portion is a coaxial annular sloped surface.

7. The integrated structure of claim 6, wherein the second support structure has a chamfered surface corresponding to the coaxial annular sloped surface that move the second moving end to make the second contact to generate a depressing signal.

8. The integrated structure of claim 7, wherein the second contact has a conductive elastic blade located on a moving path of the second moving end such that the second moving end moves to the elastic blade when the directional wheel is depressed downwards to make the elastic blade in contact with the second contact so that the second contact generates the depressing signal.

9. The integrated structure of claim 1, wherein the second support structure has a flexible support leg at a bottom end, the support leg having a bend spot to serve as a flexible fulcrum when the support leg receives a force from an upper side so that the support leg is movable downward and bounces back.

10. The integrated structure of claim 9, wherein the support leg has a sliding portion at the bottom thereof.

11. The integrated structure of claim 10, wherein the sliding portion is mounted onto a sliding track to allow the second support structure to slide reciprocally.

12. The integrated structure of claim 1, wherein the first contact and the second contact are respectively a first electrode and a second electrode to detect moving displacements of the first moving end and the second moving end to change conductive conditions of the first electrode and the second electrode to determine signal generation.
